(19) United States
(12) Patent Application Publication
(10) Pub. No.: US 2008/0139437 A1
(43) Pub. Date: Jun. 12, 2008

(54) Ether-containing paint removing composition

(76) Inventor: John W. Power, Memphis, TN (US)

Correspondence Address: BAKER, DONELSON, BEARMAN, CALDWELL & BERKOWITZ, SIX CONCOURSE PARKWAY, SUITE 3100, ATLANTA, GA, 30328, US

(21) Appl. No.: 11/595,735

(22) Filed: Nov. 10, 2006

(51) Int. Cl. C09D 9/00

(52) U.S. Cl. 510/208; 510/201

(57) ABSTRACT

A composition and related process for removing paint from a substrate in which the composition contains an aprotic polar solvent, an ether-containing compound, an evaporation retarder and a solvent for the evaporation retarder.

### TECHNICAL FIELD

The present invention relates to a paint removing composition. In a more specific aspect, this invention relates to an ether-containing composition for removing paint from a substrate.

This invention also relates to a process for removing paint from a substrate by using an ether-containing composition.

In this application, the term “paint” will be understood to refer to coatings (pigmented or unpigmented) used to protect and/or beautify substrates, such as epoxies, enamels, latexes, primers, basecoats, oil based paints, varnishes, 2-part urethane finishes as provided by original equipment manufacturers and polyurethane finishes. As used in this application, the terms “paint removing”, “paint remover” and “paint removal” refer to compositions which remove or facilitate the removal of paint from a substrate.

The ether-containing paint removing composition of this invention is formulated to remove paint from a substrate within a reasonable period of time; for example, within about 4 hours or less.

### BACKGROUND OF THE INVENTION

Chemical based paint removers (also referred to as “paint strippers”) have enjoyed widespread commercial application due to their relative ease of use when compared to various physical methods of paint removal, such as scraping and sanding. Many of these paint removers are solvent based, utilizing methylene chloride, methanol, acetone, toluene, xylene or other solvent components. While these solvents yield significant paint removal, they may also present potential health, safety and environmental concerns to both the user and the surrounding environment.

U.S. Pat. No. 2,507,983 discloses a paint stripper which contains methylene chloride and methyl cellulose, which is a thickening agent used to increase the viscosity of the formulation. Methylene chloride is an effective low cost paint stripper characterized by a high vapor pressure which causes the methylene chloride to evaporate very rapidly. This high vapor pressure may lead to a vapor inhalation hazard. In addition, methylene chloride is a suspected carcinogen as well as a dermal irritant. A further concern of methylene chloride is possible ground water contamination when the residual stripper is removed from the substrate.

In an effort to reduce the health, safety and toxicity concerns related to methylene chloride based paint strippers, several formulations utilizing N-methyl-2-pyrrolidone (NMP) have been developed. Because of its effectiveness, low toxicity, biodegradability and high flash point, NMP has been proposed as a substitute for chlorinated solvents. For example, U.S. Pat. Nos. 4,120,810; 4,666,626; 4,749,510; 4,812,255; 5,006,279; and 5,049,300 disclose paint stripping compositions which include NMP and other components, such as aromatic hydrocarbons or other aromatic solvents.

However, these and other formulations may still present potential health, safety and dermal hazards based on the absorption rate of the particular aromatic hydrocarbon or aromatic solvent used. In addition, many aromatic hydrocarbons are believed to be carcinogenic and may pose environmental concerns.

U.S. Pat. No. 5,011,621 relates to mixtures of NMP, selected co-solvents (which may include aromatic hydrocarbons and terpenes such as d-limonene) and one or more plant or animal-derived oils as a means to effectively remove paint from substrates.

As local, state and federal governments require stricter controls on the amount of volatile organic compounds and possible water table contaminating chemicals which can be used, the compositions used in paint removal must be changed to comply with those controls.

Additionally, when working with compositions for paint removal, the user must be concerned about the disposal of hazardous substances. This concern is important as environmental issues become more significant.

Thus, the industry is in need of an effective paint removal composition which eliminates or minimizes environmental concerns and the disadvantages or problems encountered with the prior art compositions and which removes polymeric finishes from original equipment manufacturers.

### SUMMARY OF THE INVENTION

The present invention provides a composition for removing paint from a substrate. As compared to many compositions of the prior art as described above, the composition of this invention does not contain a chlorinated solvent, such as methylene chloride.

The present invention also provides a process for using this composition to remove paint from a substrate.

Briefly described, the present invention removes paint from a substrate by using a new and advantageous composition which contains at least one aprotic polar solvent, at least one ether- containing compound, at least one evaporation retarder and at least one solvent for the evaporation retarder. These components are used in a defined weight percent range, based on the total weight of the composition.

Accordingly, an object of this invention is to provide a composition for removing paint from a substrate.

Another object of this invention is to provide a paint removing composition which contains no more than 50 percent volatile organic compounds.

Another object of this invention is to provide a paint removing composition which does not contain a chlorinated solvent, such as methylene chloride.

Another object of this invention is to provide a paint removing composition which provides less hazardous waste for disposal.

Still another object of this invention is to provide a process for removing paint from a substrate.

Still another object of this invention is to provide a process for removing paint from a substrate by using a composition which contains no more than 50 percent volatile organic compounds.

Still another object of this invention is to provide a process for removing paint from a substrate by using a composition which provides less hazardous waste for disposal.

Still another object of this invention is to provide a process for removing paint from a substrate by using a composition which does not contain a chlorinated solvent, such as methylene chloride.

These and other object, features and advantages of the present invention will become apparent from the following description.

### DETAILED DESCRIPTION OF THE INVENTION

The present invention provides a composition for removing paint from a substrate, wherein the composition comprises at least one aprotic polar solvent, at least one ether-containing compound, at least one evaporation retarder and at least one solvent for the evaporation retarder. The present invention also provides a process by which this composition is used to remove paint from a substrate.

As used in this application, the term “substrate” will be understood to include wood, metal, plastic, masonry and other types of surfaces to which paint can be applied.

As defined above, there are four essential components in the composition of this invention. These components and their corresponding weight percent ranges are shown below, with the weight percents being based on the total weight of the composition.

| Component | Weight Percent Range |
|---|---|
| Aprotic Polar Solvent | from about 1.0 to about 50.0 |
| | (preferably about 10.0 to about 40.0) |
| Ether-Containing | from about 1.0 to about 70.0 |
| Compound | (preferably about 10.0 to about 50.0) |
| Evaporation Retarder | from about 0.25 to about 5.0 |
| | (preferably about 0.5 to about 4.0) |
| Solvent for Evaporation | from about 1.0 to about 50.0 |
| Retarder | (preferably about 5.0 to about 40.0) |

As stated above, the composition of this invention contains at least one aprotic polar solvent, i.e., a polar solvent that is incapable of acting as a proton donor. Examples of suitable aprotic polar solvents include methyl acetate; t-butyl acetate; N-methyl-2-pyrrolidone; acetone; dimethyl sulfoxide; dibasic esters, such as dimethyl adipate, dimethyl glutarate, dimethyl glutamate and dimethyl succinate; other esters such as methyl soyate and the methyl, ethyl and propyl esters of fatty acids; and ketones such as acetone and methyl ethyl ketone. A mixture of aprotic polar solvents can be used. The preferred solvents are acetone, N-methyl-2-pyrolidone and dibasic esters.

A second essential component of the composition of this invention is at least one ether-containing compound. Examples of suitable ether-containing compounds are ethyl and propyl glycol ethers; ethyl and propyl glycol acetates; polyethyl and polypropyl ethers; polyethyl and polypropyl acetates; 1,3-dioxolane; 1,3,5-trioxane; 5-hydroxy-1,3-dioxane; 4-hydroxymethyl-1,3-dioxolone; tetrahydrofuran; and methyal. A mixture of these ether-containing compounds can be used. The preferred ether-containing compound is 1,3-dioxolane.

A third essential component of the composition of this invention is at least one evaporation retarder, which is a material that prevents or at least substantially minimizes evaporation of the aprotic polar solvent and the ether-containing compound. Preferred evaporation retarders are wax compounds, such as paraffin wax, and alkylated polyvinylpyrolidones. A mixture of these evaporation retarders can be used.

A fourth essential component of the composition of this invention is at least one solvent for the evaporation retarder. This solvent is used to maintain the evaporation retarder in solution and hold the ether-containing compound and the aprotic polar solvent in contact with the substrste until the ether-containing compound and the aprotic polar solvent are able to attack and remove the paint. Examples of suitable solvents for the evaporation retarder are aliphatic and aromatic hydrocarbon solvents, such as toluene, xylene, high flash point solvents (such as aromatic 100 solvent), mineral spirits and mineral oil. A mixture of these solvents can be used.

Optional components (i.e., adjuvants) may be added to the composition of this invention to achieve other objectives. Examples of these optional components are alkaline activating components, fillers, colorants, stabilizers, surfactants, bittering agents, other solvents, free water, thickening agents, activators for thickening agents, pH adjusting agents, etc. These optional components can be used in the amounts necessary to achieve a particular objective.

Examples of fillers which can optionally be used in this invention include the starches, cellulosic materials, flour, carbohydrates and mixtures thereof. Suitable starches include potato, rice and corn starch and mixtures thereof. Suitable cellulosic materials include hydroxypropyl methyl cellulose and hydroxypropyl cellulose. Suitable carbohydrates include monosaccharides, disaccharides and polysaccharides, such as glucose and lactose. Mixtures of two or more fillers can be used.

A preferred optional component is a thickening agent, which can be an inorganic or organic material. Examples of suitable thickening agents are silicas (such as fumed or precipitated silicas), metallic silicates, clays, modified celluloses, polymeric materials (such as polyacrylates) and gums. Mixtures of thickening agents can also be used. Preferred thickening agents are methyl, ethyl and propyl cellulose; hydroxmethyl, hydroxyethyl and hydroxypropyl cellulose; and clay.

For example, a circumstance in which a thickening agent would preferably be used is where paint is being removed from a non-horizontal surface. The thickening agent would be useful in maintaining the paint removing composition in place (i.e., in contact with the non-horizontal surface).

If used in the paint removing composition of this invention, the thickening agent is present in an amount from about 0.1 to about 10.0 percent by weight, preferably about 1.0 to about 5.0 percent by weight, based on the total weight of the composition. Some thickening agents (such as clays or cellulose ethers) may require alcohols, such as methanol or ethanol, for activation and thickening.

A further optional component is an alkaline activating component, examples of which include sodium hydroxide, potassium hydroxide, glycolamine, diglycolamine, monoethanolamine, ammonium hydroxide, ammonia, aqua ammonia, diethanolamine, triethanolamine and mixtures thereof. These components are especially useful when a 2-layer finish (such as a 2-layer urethane finish) is being removed from a substrate, such as might be found in automotive coatings.

If used in the paint removing composition of this invention, the alkaline activating component is present in an amount from about 0.1 to about 10.0 percent by weight, preferably about 1.0 to about 5.0 percent by weight, based on the total weight of the composition.

The use of a surfactant is optional in the composition of this invention, but can sometimes be used to improve the ability of the composition to remove paint and aid in the cleanup of loosened paint. Examples of suitable surfactants include tall oil soaps, oleic acid soaps, nonylphenolethyoxylates, other alcoholic ethoxylate compounds and mixtures of such compounds.

If used in the composition of this invention, the surfactant is present in an amount from about 0.1 to about 10.0 percent by weight, preferably about 1.0 to about 5.0 percent, by weight, based on the total weight of the composition.

The paint removing composition of this invention can be made by either a batch or continuous process.

In one batch process, the aprotic polar solvent and the ether-containing compound are added to a first blend tank, followed by the addition of any amines, alcohols and additional solvents, and then any water or aqueous mixtures are added slowly with stirring. The stirring step can be accomplished by various means, such as paddle mixing, high speed dispersion or homogenization. The solvent for the evaporation retarder is added to a second blend tank, followed by the addition of the evaporation retarder, any thickeners and any surfactants. The second blend tank is slowly added to the first blend tank, with stirring.

Alternatively, the solvent for the evaporation retarder, the evaporation retarder, any thickeners and any surfactants are added to a blend tank. The contents of the blend tank are then subjectd to high speed dispersion. The aprotic polar solvent, the ether-containing compound and any stabilizer are added sequentially to the blend tank. Finally, any thickeners, any activators, any water or aqueous mixtures and any alkaline compounds are added to the blend tank and subjected to high speed dispersion until the desired consistency is achieved.

The present invention is further illustrated by the following example which is designed to teach those of ordinary skill in the art how to practice this invention and to represent the best mode contemplated for carrying out this invention.

### EXAMPLE

The following paint removing composition of this invention is prepared using a batch process as generally described above.

| Component | Weight Percent |
|---|---|
| Xylene | 20.800 |
| Foammaster NDW (defoamer) | 0.210 |
| Nonoxylnol 9 (surfactant) | 3.000 |
| Yellow Dye | 0.003 |
| Tall Oil (surfactant) | 5.600 |
| ParaffinWax MP127 | 1.670 |
| Tixogel MP-250 (a modified clay) | 2.350 |
| Reosil QS-102 (a fumed silica) | 1.300 |
| Acetone | 30.66 |
| Methanol | 4.000 |
| 80% Caustic Soda | 1.676 |
| Diglycolamine | 0.900 |
| Aqua Ammonia | 2.000 |
| Water | 0.831 |
| 1,3-Dioxolane | 25.000 |
| | 100.000 |

Excellent paint removal results were obtained when this composition was used to remove oil based and latex paints from a substrate and from 2-part urethane finishes from original equipment manufacturers.

This invention has been described in detail with particular reference to certain embodiments, but variations and modifications can be made without departing from the spirit and scope of the invention as defined in the following claims.

What is claimed is:

1. A composition for removing paint from a substrate, wherein the composition comprises:
A. from about 1.0 to about 50.0 weight percent of at least one aprotic polar solvent;
B. from about 1.0 to about 70.0 weight percent of at least one ether-containing compound;
C. from about 0.25 to about 5.0 weight percent of at least one evaporation retarder; and
D. from about 1.0 to about 50.0 weight percent of at least one solvent for the evaporation retarder;
wherein the composition is free of methylene chloride.

2. A composition as defined by claim 1 wherein the aprotic polar solvent is methyl acetate; t-butyl acetate; N-methyl-2-pyrrolidone; acetone; dimethyl sulfoxide; a dibasic ester; or a mixture thereof.

3. A composition as defined by claim 2 wherein the aprotic polar solvent is acetone, N-methyl-2-pyrrolidone or a dibasic ester.

4. A composition as defined by claim 1 wherein the ether-containing compound is 1,3-dioxolane; 1,3,5-trioxolane; methylal or a mixture thereof.

5. A composition as defined by claim 4 wherein the ether-containing compound is 1,3-dioxolane.

6. A composition as defined by claim 1 wherein the evaporation retarder is a wax compound.

7. A composition as defined by claim 6 wherein the evaporation retarder is paraffin wax.

8. A composition as defined by claim 1 wherein the solvent for the evaporation retarder is an aliphatic or aromatic hydrocarbon solvent.

9. A composition as defined by claim 8 wherein the solvent for the evaporation retarder is toluene, xylene, aromatic 100 solvent, mineral spirits, mineral oil or a mixture thereof.

10. A composition for removing paint from a substrate, wherein the composition comprises:
A. from about 1.0 to about 50.0 weight percent of at least one aprotic polar solvent;
B. from about 1.0 to about 70.0 weight percent of at least one ether-containing compound;
C. from about 0.25 to about 5.0 weight percent of at least one evaporation retarder;
D. from about 1.0 to about 50.0 weight percent of at least one solvent for the evaporation retarder; and
E. from about 0.1 to about 10.0 weight percent of at least one thickening agent;
wherein the composition is free of methylene chloride.

11. A composition for removing paint from a substrate, wherein the composition comprises:
A. from about 1.0 to about 50.0 weight percent of at least one aprotic polar solvent;
B. from about 1.0 to about 70.0 weight percent of at least one ether-containing compound;
C. from about 0.25 to about 5.0 weight percent of at least one evaporation retarder;
D. from about 1.0 to about 50.0 weight percent of at least one solvent for the evaporation retarder; and
E. from about 0.1 to about 10.0 percent of at least one alkaline activating agent;
wherein the composition is free of methylene chloride.

12. A process for removing paint from a substrate, wherein the process comprises treating the substrate with a composition which comprises:
A. from about 1.0 to about 50.0 percent weight of at least one aprotic polar solvent;
B. from about 1.0 to about 70.0 percent weight of at least one ether-containing compound;
C. from about 0.25 to about 5.0 weight percent of at least one evaporation retarder; and
D. from about 1.0 to about 50.0 weight percent of at least one solvent for the evaporation retarder;
wherein the composition is free of methylene chloride.

13. A process for removing paint from a substrate, wherein the process comprises treating the substrate with a composition which comprises:
A. from about 1.0 to about 50.0 weight percent of at least one aprotic polar solvent;
B. from about 1.0 to about 70.0 weight percent of at least one ether-containing compound;
C. from about 0.25 to about 5.0 weight percent of at least one evaporation retarder;
D. from about 1.0 to about 50.0 weight percent of at least one solvent for the evaporation retarder; and
E. from about 0.1 to about 10.0 percent of at least one alkaline activating agent;
wherein the composition is free of methylene chloride.

14. A process as defined by claim 13 wherein the substrate is an automotive part having a 2-part urethane finish.
